(19) United States
(12) Patent Application Publication
(10) Pub. No.: US 2026/0138183 A1
(43) Pub. Date: May 21, 2026

(54) METAL FILAMENTS FOR FUSED FILAMENT FABRICATION

(71) Applicant: Stacked Circuits Printing Materials LLC, Austin, TX (US)

(72) Inventor: Brian Anthony Minnick, Purcellville, VA (US)

(21) Appl. No.: 19/395,160

(22) Filed: Nov. 20, 2025

Related U.S. Application Data
(60) Provisional application No. 63/723,159, filed on Nov. 21, 2024.
(60) Provisional application No. 63/862,990, filed on Aug. 13, 2025.

(51) Int. Cl. B22F 10/18; B22F 1/05; B22F 1/062; B22F 1/065; B22F 3/20; B33Y 10/00; B33Y 70/10; C22C 12/00; C22C 13/00

(52) U.S. Cl. CPC B22F 10/18; B22F 1/05; B22F 1/062; B22F 1/065; B22F 3/20; B33Y 10/00; B33Y 70/10; C22C 12/00; C22C 13/00; B22F 2301/15; B22F 2301/30; B22F 2304/10; B22F 2304/15; B22F 2998/10; B22F 2999/00

(57) ABSTRACT

Disclosed herein are metal filaments. Also disclosed are methods of making and using said metal filaments.

### RELATED APPLICATIONS

This application claims the benefit of priority to U.S. Provisional Application No. 63/862,990, filed Aug. 13, 2025, and U.S. Provisional Application No. 63/723,159, filed Nov. 21, 2024; the contents of each of which are fully incorporated by reference herein.

### BACKGROUND

Fused-Filament-Fabrication (FFF) or filament-based additive manufacturing (AM) makes up the majority of desktop and consumer grade 3D printing technology and yet no pure metal filament has been commercialized. Many other AM processes exist to print metal objects, but require dangerous metal powders, prohibitively expensive machines, or extensive post processing to create a final part. Such factors make metal AM difficult to access for general consumers, independent prototyping labs, and universities. Filament-based machines are generally more accessible to smaller labs and individuals as they avoid the previous three factors, but are limited in the materials that are compatible.

Metal materials are generally incompatible with the FFF printing process due to the high surface tension of molten metal after leaving the printing nozzle. This effect causes the metal to form metal beads or spheres rather than long continuous extrusions required for successful FFF printing. Previous experimental metal FFF filaments are single alloys that have been designed to be printed in the “mushy” region: a temperature and composition which, given the thermodynamics of the specific material, results in a semi-molten metal between the solidus and liquidus. This semi-molten metal avoids the issue of surface tension and can form solid continuous traces successfully. However, this process requires extremely precise temperature and alloy control to maintain the metal in the semi-molten state during printing. For the material to be used on commercially available FFF 3D printers, a wider temperature range is required. Common FFF extruders are not capable of holding the precise temperatures required to print semi-molten alloys.

Several commercially available FFF materials include metal within a polymer or wax binder. These materials generally fall into two categories: materials where the binder is included in the final form and materials where this binder is designed to be removed. Materials designed to include the binder in the final form can exhibit some limited properties of a bulk metal, such as conductivity or improved mechanical strength over the binder material alone, but vastly underperform when compared to any of the properties of the metal included in the binder if taken by itself. Examples of this material class include “Electrifi Conductive Filament” from MULTI3D and “Copper-filled Metal Composite HTPLA” from Protopasta, among others.

FFF printing materials designed to have removable binders are generally more successful at recovering the properties of the metal additive but require post processing steps to remove the binder. Such steps are often dangerous and prohibitively expensive or complex for individuals, small labs, and universities. An example of an FFF AM system with a removable binder is the “Studio System” from Desktop Metal, among others.

Given the challenges associated with 3D printing metal, new metal filaments for use in fused filament fabrication are needed.

### SUMMARY OF THE INVENTION

In certain aspects, the present disclosure provides a metal filament comprising a plurality of metal particles embedded within a metal matrix, wherein:
the metal matrix comprises:
   about 30% to about 99.9% tin (w/w);
   optionally about 0% to about 70% bismuth (w/w);
   optionally about 0% to about 5% silver (w/w); and
   optionally about 0% to about 5% copper; and
the metal particles comprise:
   optionally about 0% to about 99% tin (w/w);
   optionally about 0% to about 5% silver (w/w); and
   about 0.1% to about 100% copper (w/w).

In other aspects, the present disclosure provides a method of making a metal filament disclosed herein, comprising:
providing a first metal paste and a second metal paste, wherein:
   the first metal paste comprises:
      about 30% to about 99.9% tin (w/w);
      optionally about 0% to about 70% bismuth (w/w);
      optionally about 0% to about 5% silver (w/w); and
      optionally about 0% to about 5% copper (w/w); and
   wherein the second metal paste comprises:
      optionally about 0% to about 99% tin (w/w);
      optionally about 0% to about 5% silver (w/w); and
      about 0.1% to about 100% copper (w/w);
mixing the first paste and the second metal paste to form a mixture;
heating the mixture to a temperature above a melting temperature of the first metal paste but below a melting temperature of the second metal paste, thereby forming a heated mixture;
and extruding the heated mixture through a nozzle to form a metal filament disclosed herein.

In further aspects, the present disclosure provides a method of using a metal filament disclosed herein for fused filament fabrication with a 3D printer.

In yet further aspects, the present disclosure provides a method of using a metal filament disclosed herein to print a continuous line of material.

### BRIEF DESCRIPTION OF THE DRAWINGS

FIG. 1A shows an isometric view of the end of a metal filament.

FIG. 1B shows a cross-sectional view of a metal filament. The metal matrix is identified by reference numeral 1, and the inset metal particles are identified by reference numeral 2.

FIG. 2 shows a line of metal printed using a standard metal alloy and a conventional nozzle.

FIG. 3. shows a line of metal printed using a metal filament of the disclosure and a conventional nozzle.

FIG. 4. shows a shaped line of metal printed using a metal filament of the disclosure and a conventional nozzle.

FIG. 5. shows a micrograph of an alloy containing metal particles within a metal matrix.

FIG. 6. shows micrographs of alloys containing either copper particles or T5 solder paste particles.

### DETAILED DESCRIPTION OF THE INVENTION

Disclosed herein are metal filaments that are useful for printing metal products by fused filament fabrication. Said filaments have many useful and surprising properties. For example, the metal filaments of the disclosure may be useful for producing electrical traces, radio frequency antennas, structural metal parts, and heat sinks by fused filament fabrication.

In certain aspects, the present disclosure provides a metal filament comprising a plurality of metal particles embedded within a metal matrix, wherein:
the metal matrix comprises:
   about 30% to about 99.9% tin (w/w);
   optionally about 0% to about 70% bismuth (w/w);
   optionally about 0% to about 5% silver (w/w); and
   optionally about 0% to about 5% copper; and
the metal particles comprise:
   optionally about 0% to about 99% tin (w/w);
   optionally about 0% to about 5% silver (w/w); and
   about 0.1% to about 100% copper (w/w).

In certain aspects, the present disclosure provides a metal filament comprising a plurality of metal particles embedded within a metal matrix, wherein:
the metal matrix comprises:
   about 30% to about 99.9% tin (w/w);
   about 0% to about 70% bismuth (w/w);
   about 0% to about 5% silver (w/w); and
   about 0% to about 5% copper; and
the metal particles comprise:
   about 0% to about 99% tin (w/w);
   about 0% to about 5% silver (w/w); and
   about 0.1% to about 100% copper (w/w).

In some embodiments, a melting temperature of the metal matrix is lower than a melting temperature of the metal particles.

In some embodiments, the metal matrix comprises:
about 30% to about 50% tin (w/w);
about 50% to about 70% bismuth (w/w); and
about 0% to about 5% silver (w/w).

In some embodiments, the metal matrix comprises about 30%, about 30.5%, about 31%, about 31.5%, about 32%, about 32.5%, about 33%, about 33.5%, about 34%, about 34.5%, about 35%, about 35.5%, about 36%, about 36.5%, about 37%, about 37.5%, about 38%, about 38.5%, about 39%, about 39.5%, about 40%, about 40.5%, about 41%, about 41.5%, about 42%, about 42.5%, about 43%, about 43.5%, about 44%, about 44.5%, about 45%, about 45.5%, about 46%, about 46.5%, about 47%, about 47.5%, about 48%, about 48.5%, about 49%, about 49.5%, or about 50% tin (w/w).

In some embodiments, the metal matrix comprises about 37.5% tin (w/w). In other embodiments, the metal matrix comprises about 42% tin (w/w). In further embodiments, the metal matrix comprises about 45% tin (w/w).

In some embodiments, the metal matrix comprises about 50%, about 50.5%, about 51%, about 51.5%, about 52%, about 52.5%, about 53%, about 53.5%, about 54%, about 54.5%, about 55%, about 55.5%, about 56%, about 56.5%, about 57%, about 57.5%, about 58%, about 58.5%, about 59%, about 59.5%, about 60%, about 60.5%, about 61%, about 61.5%, about 62%, about 62.5%, about 63%, about 63.5%, about 64%, about 64.5%, about 65%, about 65.5%, about 66%, about 66.5%, about 67%, about 67.5%, about 68%, about 68.5%, about 69%, about 69.5%, or about 70% bismuth (w/w).

In some embodiments, the metal matrix comprises about 55% bismuth (w/w). In other embodiments, the metal matrix comprises about 57% bismuth (w/w). In further embodiments, the metal matrix comprises about 62.5% bismuth (w/w).

In some embodiments, the metal matrix comprises about 0.1%, about 0.2%, about 0.3%, about 0.4%, about 0.5%, about 0.6%, about 0.7%, about 0.8%, about 0.9%, about 1.0%, about 1.1%, about 1.2%, about 1.3%, about 1.4%, about 1.5%, about 1.6%, about 1.7%, about 1.8%, about 1.9%, about 2.0%, about 2.1%, about 2.2%, about 2.3%, about 2.4%, about 2.5%, about 2.6%, about 2.7%, about 2.8%, about 2.9%, about 3.0%, about 3.1%, about 3.2%, about 3.3%, about 3.4%, about 3.5%, about 3.6%, about 3.7%, about 3.8%, about 3.9%, about 4.0%, about 4.1%, about 4.2%, about 4.3%, about 4.4%, about 4.5%, about 4.6%, about 4.7%, about 4.8%, about 4.9%, or about 5.0% of silver (w/w).

In some embodiments, the metal matrix comprises about 1% silver (w/w). In alternative embodiments, the metal matrix comprises 0% silver (i.e., the metal matrix does not comprise silver or is substantially free of silver) (w/w).

In some embodiments, the metal matrix comprises 0% copper (i.e., the metal matrix does not comprise copper or is substantially free of copper) (w/w).

In some embodiments, the metal matrix comprises about 42% tin, about 57% bismuth, and about 1% silver (w/w). In other embodiments, the metal matrix comprises about 45% tin and about 55% bismuth (w/w). In further embodiments, the metal matrix comprises about 37.5% tin and about 62.5% bismuth (w/w).

In some embodiments, the metal matrix comprises about 99.3% tin (w/w).

In some embodiments, the metal matrix comprises about 0.7% copper (w/w).

In some embodiments, the metal matrix comprises about 99.3% tin and about 0.7% copper (w/w).

In some embodiments, the metal particles comprise:
about 90% to about 99% tin (w/w);
about 1% to about 5% silver (w/w); and
about 0.1% to about 3% copper (w/w).

In some embodiments, the metal particles comprise about 90%, about 90.5%, about 91%, about 91.5%, about 92%, about 92.5%, about 93%, about 93.5%, about 94%, about 94.5%, about 95%, about 95.5%, about 96%, about 96.5%, about 97%, about 97.5%, about 98%, about 98.5%, or about 99% tin (w/w).

In some embodiments, the metal particles comprise about 96.5% tin (w/w).

In some embodiments, the metal particles comprise about 1%, about 1.5%, about 2%, about 2.5%, about 3%, about 3.5%, about 4%, about 4.5%, or about 5% silver (w/w).

In some embodiments, the metal particles comprise about 3% silver (w/w).

In some embodiments, the metal particles comprise about 0.1%, about 0.2%, about 0.3%, about 0.4%, about 0.5%, about 0.6%, about 0.7%, about 0.8%, about 0.9%, about 1.0%, about 1.1%, about 1.2%, about 1.3%, about 1.4%, about 1.5%, about 1.6%, about 1.7%, about 1.8%, about 1.9%, about 2.0%, about 2.1%, about 2.2%, about 2.3%, about 2.4%, about 2.5%, about 2.6%, about 2.7%, about 2.8%, about 2.9%, or about 3.0% copper (w/w).

In some embodiments, the metal particles comprise about 0.5% copper (w/w).

In some embodiments, the metal particles comprise about 96.5% tin, about 3% silver, and about 0.5% copper (w/w).

In some embodiments, the metal particles comprise about 100% copper (w/w).

In some embodiments, the metal particles comprise a metal coating.

In some embodiments, the metal coating is 100% nickel (w/w).

In some embodiments, the filament has a diameter of about 1 to about 5 mm. In alternative embodiments, the filament has a diameter of about 2.85 mm.

In some embodiments, the filament has a diameter of about 1.75 mm.

In some embodiments, the filament has a resistance of about 0 Ωcm to about 0.001 Ωcm. In further embodiments, the filament has a resistance of about 0 Ωcm to about 0.0001 Ωcm.

In some embodiments, the metal particles have an average diameter of about 0 μm to about 50 μm.

In some embodiments, the metal particles have an average diameter of about 0 μm to about 44 μm.

In some embodiments, the metal particles are manufactured by air atomization.

In some embodiments, the metal particles are substantially spherical. In some embodiments, the metal particles have an average sphericity greater than 0.6, greater than 0.65, greater than 0.7, greater than 0.75, greater than 0.8, greater than 0.85, greater than 0.9, or greater than 0.95.

In some embodiments, the metal particles have an average sphericity of 0.6 to 1.

In some embodiments, the metal particles have an average sphericity of 0.6 to 0.7, of 0.7 to 0.8, of 0.8 to 0.9, or of 0.9 to 1.0.

In some embodiments, the metal particles have an average sphericity of 0.6 to 0.65, of 0.65 to 0.7, of 0.7 to 0.75, of 0.75 to 0.8, of 0.8 to 0.85, of 0.85 to 0.9, of 0.9 to 0.95, or of 0.95 to 1.0.

In some embodiments, the filament does not comprise a polymer.

In some embodiments, the filament does not comprise a wax.

In certain aspects, the present disclosure provides a metal filament consisting essentially of a plurality of metal particles embedded within a metal matrix, wherein:
the metal matrix consists essentially of:
   about 30% to about 50% tin (w/w);
   about 50% to about 70% bismuth (w/w); and
   about 0% to about 5% silver (w/w); and
the metal particles consist essentially of:
   about 90% to about 99% tin (w/w);
   about 1% to about 5% silver (w/w); and
   about 0.1% to about 3% copper (w/w).

In some aspects, the present disclosure provides a method of making a metal filament disclosed herein, comprising:
providing a first metal paste and a second metal paste, wherein:
   the first metal paste comprises:
      about 30% to about 99.9% tin (w/w);
      about 0% to about 70% bismuth (w/w);
      about 0% to about 5% silver (w/w); and
      about 0% to about 5% copper (w/w); and
   wherein the second metal paste comprises:
      about 0% to about 99% tin (w/w);
      about 0% to about 5% silver (w/w); and
      about 0.1% to about 100% copper (w/w);
mixing the first paste and the second metal paste to form a mixture;
heating the mixture to a temperature above a melting temperature of the first metal paste but below a melting temperature of the second metal paste, thereby forming a heated mixture; and
extruding the heated mixture through a nozzle to form a metal filament disclosed herein.

In some embodiments, the first metal paste comprises:
about 30% to about 50% tin (w/w);
about 50% to about 70% bismuth (w/w); and
about 0% to about 5% silver (w/w).

In some embodiments, the first metal paste comprises about 30%, about 30.5%, about 31%, about 31.5%, about 32%, about 32.5%, about 33%, about 33.5%, about 34%, about 34.5%, about 35%, about 35.5%, about 36%, about 36.5%, about 37%, about 37.5%, about 38%, about 38.5%, about 39%, about 39.5%, about 40%, about 40.5%, about 41%, about 41.5%, about 42%, about 42.5%, about 43%, about 43.5%, about 44%, about 44.5%, about 45%, about 45.5%, about 46%, about 46.5%, about 47%, about 47.5%, about 48%, about 48.5%, about 49%, about 49.5%, or about 50% tin (w/w).

In some embodiments, the first metal paste comprises about 37.5% tin (w/w). In other embodiments, the first metal paste comprises about 42% tin (w/w). In further embodiments, the first metal paste comprises about 45% tin (w/w).

In some embodiments, the first metal paste comprises about 50%, about 50.5%, about 51%, about 51.5%, about 52%, about 52.5%, about 53%, about 53.5%, about 54%, about 54.5%, about 55%, about 55.5%, about 56%, about 56.5%, about 57%, about 57.5%, about 58%, about 58.5%, about 59%, about 59.5%, about 60%, about 60.5%, about 61%, about 61.5%, about 62%, about 62.5%, about 63%, about 63.5%, about 64%, about 64.5%, about 65%, about 65.5%, about 66%, about 66.5%, about 67%, about 67.5%, about 68%, about 68.5%, about 69%, about 69.5%, or about 70% bismuth (w/w).

In some embodiments, the first metal paste comprises about 55% bismuth (w/w). In other embodiments, the first metal paste comprises about 57% bismuth (w/w). In further embodiments, the first metal paste comprises about 62.5% bismuth (w/w).

In some embodiments, the first metal paste comprises about 0.1%, about 0.2%, about 0.3%, about 0.4%, about 0.5%, about 0.6%, about 0.7%, about 0.8%, about 0.9%, about 1.0%, about 1.1%, about 1.2%, about 1.3%, about 1.4%, about 1.5%, about 1.6%, about 1.7%, about 1.8%, about 1.9%, about 2.0%, about 2.1%, about 2.2%, about 2.3%, about 2.4%, about 2.5%, about 2.6%, about 2.7%, about 2.8%, about 2.9%, about 3.0%, about 3.1%, about 3.2%, about 3.3%, about 3.4%, about 3.5%, about 3.6%, about 3.7%, about 3.8%, about 3.9%, about 4.0%, about 4.1%, about 4.2%, about 4.3%, about 4.4%, about 4.5%, about 4.6%, about 4.7%, about 4.8%, about 4.9%, or about 5.0% of silver (w/w).

In some embodiments, the first metal paste comprises about 1% silver (w/w). In alternative embodiments, the first metal paste comprises 0% silver (i.e., the metal matrix does not comprise silver or is substantially free of silver) (w/w).

In some embodiments, the first metal paste comprises 0% copper (i.e., the metal matrix does not comprise copper or is substantially free of copper) (w/w).

In some embodiments, the first metal paste comprises about 42% tin, about 57% bismuth, and about 1% silver (w/w). In other embodiments, the first metal paste comprises about 45% tin and about 55% bismuth (w/w). In further embodiments, the first metal paste comprises about 37.5% tin and about 62.5% bismuth (w/w).

In some embodiments, the first metal paste comprises about 99.3% tin (w/w).

In some embodiments, the first metal paste comprises about 0.7% copper (w/w).

In some embodiments, the first metal paste comprises about 99.3% tin and about 0.7% copper (w/w).

In some embodiments, the second metal paste comprises:
about 90% to about 99% tin (w/w);
about 1% to about 5% silver (w/w); and
about 0.1% to about 3% copper (w/w).

In some embodiments, the second metal paste comprises about 90%, about 90.5%, about 91%, about 91.5%, about 92%, about 92.5%, about 93%, about 93.5%, about 94%, about 94.5%, about 95%, about 95.5%, about 96%, about 96.5%, about 97%, about 97.5%, about 98%, about 98.5%, or about 99% tin (w/w).

In some embodiments, the second metal paste comprises about 96.5% tin (w/w).

In some embodiments, the second metal paste comprises about 1%, about 1.5%, about 2%, about 2.5%, about 3%, about 3.5%, about 4%, about 4.5%, or about 5% silver (w/w).

In some embodiments, the second metal paste comprises about 3% silver (w/w).

In some embodiments, the second metal paste comprises about 0.1%, about 0.2%, about 0.3%, about 0.4%, about 0.5%, about 0.6%, about 0.7%, about 0.8%, about 0.9%, about 1.0%, about 1.1%, about 1.2%, about 1.3%, about 1.4%, about 1.5%, about 1.6%, about 1.7%, about 1.8%, about 1.9%, about 2.0%, about 2.1%, about 2.2%, about 2.3%, about 2.4%, about 2.5%, about 2.6%, about 2.7%, about 2.8%, about 2.9%, or about 3.0% copper (w/w).

In some embodiments, the second metal paste comprises about 0.5% copper (w/w).

In some embodiments, the second metal paste comprises about 96.5% tin, about 3% silver, and about 0.5% copper (w/w).

In some embodiments, the second metal paste comprises about 100% copper (w/w).

In some embodiments, the mixture is heated to a temperature between about 138° C. and 217° C.

In some embodiments, the mixture is heated to a temperature of about 200° C.

In some aspects, the present disclosure provides a method of making a metal filament disclosed herein, comprising:
providing a first metal paste and a second metal paste, wherein:
   the first metal paste comprises:
   about 30% to about 99.9% tin (w/w);
   optionally about 0% to about 70% bismuth (w/w);
   optionally about 0% to about 5% silver (w/w); and
   optionally about 0% to about 5% copper (w/w); and
wherein the second metal paste comprises:
   optionally about 0% to about 99% tin (w/w);
   optionally about 0% to about 5% silver (w/w); and
   about 0.1% to about 100% copper (w/w);
mixing the first paste and the second metal paste to form a mixture;
heating the mixture to a temperature above a melting temperature of the first metal paste but below a melting temperature of the second metal paste, thereby forming a heated mixture; and
extruding the heated mixture through a nozzle to form a metal filament disclosed herein.

In some aspects, the present disclosure provides a method of making a metal filament disclosed herein, comprising:
providing a first metal paste and a second metal paste, wherein:
   the first metal paste consists essentially of:
      about 30 to about 50% tin (w/w);
      about 50 to about 70% bismuth (w/w); and
      about 0% to about 5% silver (w/w); and
   wherein the second metal paste consists essentially of:
      about 90 to about 99% tin (w/w);
      about 1 to about 5% silver (w/w); and
      about 0.1 to about 3% copper (w/w);
mixing the first paste and the second metal paste to form a mixture;
heating the mixture to a temperature above a melting temperature of the first metal paste but below a melting temperature of the second metal paste, thereby forming a heated mixture; and
extruding the heated mixture through a nozzle to form a metal filament disclosed herein.

In some aspects, the present disclosure provides a method of using a metal filament disclosed herein for fused filament fabrication with a 3D printer.

In some embodiments, the 3D printer is commercially available.

In some aspects the present disclosure provides a method of using a metal filament disclosed herein to print a continuous line of material.

In some aspects, the present disclosure provides a metal filament for 3D printing, comprising:
(a) A metal matrix of one or more alloys which is molten at a specified temperature; and
(b) A plurality of metal particles of one or more alloys which are not molten at the specified temperature.

In some embodiments, the metal particles have a coating.

In some embodiments, a material is used to prevent oxidation.

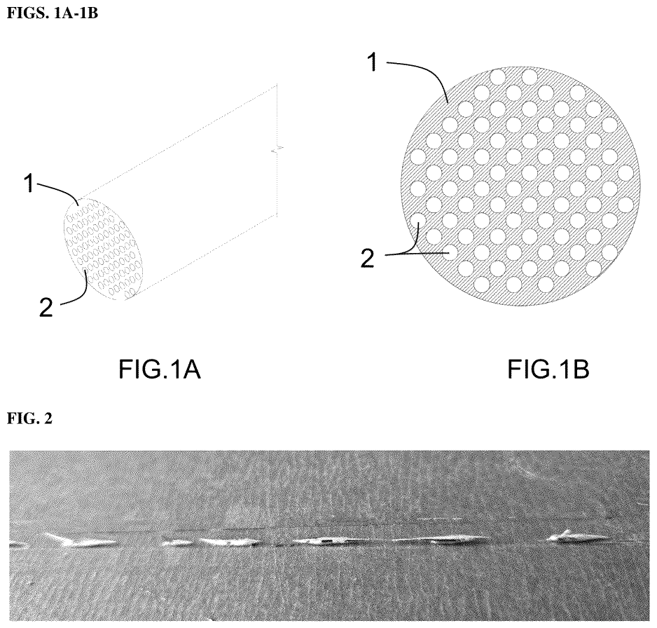

An example embodiment of a filament disclosed herein is shown in FIG. 1A (3D isometric view) and FIG. 1B (cross-sectional view). A metal FFF 3D printing material has one matrix material 1 and a plurality of inset metal particles 2. Other embodiments need not have the inset metal particles arranged in any specific manner.

In some embodiments, after the filament is printed into the desired shape, the material can be used for multiple applications including, but not limited to, electrical traces, radio frequency antennas, structural metal parts, heat sinks, and others.

In accordance with certain embodiments, a metal filament for FFF AM processes has a metal matrix, binder, or bulk material with a plurality of inset metal particles.

In some embodiments, the metal particles are small enough to fit through the nozzle of the 3D printer. In some embodiments, the shape of the particle is close to that of a sphere to reduce particle lock as it flows through the nozzle. In some embodiments, the metal particle bonds with the matrix material.

In some embodiments, the metal particle are metal-coated glass or metal-coated polymer microspheres. In alternative embodiments, the metal particles are metal-coated ceramic particles. In other embodiments, the metal particles are metal powders. In further embodiments, the metal particles are chopped metal fibers.

In some embodiments, due to the stabilizing effect of the inset metal particles, surface tension does not cause the printed material to form lumpy or discontinuous extrusions, allowing thin electrical connections or thin-walled components to be printed with high accuracy.

In some embodiments, the temperature stabilizing effect of the inset metal particles allows the material to be extruded at a wide range of temperatures, allowing commercially available FFF 3D printers with poor thermal control to print an embodiment of the filament without modification. This means the benefits of AM metal parts can be realized by individuals, small labs, or universities without investing in expensive equipment or requiring dangerous post processing steps or ingredients.

In some embodiments, the ability of the metal filaments disclosed herein to be printed with other FFF materials on commercially available 3D printers allows the printing of electronics, thermal management systems and heat sinks, and structural metal components (among other uses) inside other FFF materials. As a specific example, circuit boards may be 3D printed from a polymer material as a base or substrate and an embodiment of this filament to create fast, easy to prototype circuit boards. Materials which require heating to high temperatures to remove the binder are generally not capable of this.

In some embodiments, the metal matrix material results in a filament that does not need post processing steps to gain the value (strength, conductivity, etc.) of the metal as there is no binder to remove.

In some embodiments, post processing steps can be done if desired to enhance properties of the material, affix electronic components through a reflow soldering process, or for other reasons.

In additional embodiments, metal filaments of the disclosure containing different alloys, multiple alloys, and/or different shapes or sizes of inset metal particles can dramatically change the properties (strength, conductivity, etc.) of the printed material while retaining the stabilizing effect of the inset metal particles.

In some embodiments, the metal filaments disclosed herein provide a more reliable printing process over other pure metal FFF filaments due to the stabilizing effect of the inset metal particles. While the above description contains many specificities, these should not be construed as limitations on the scope, but rather as an exemplification of several embodiments thereof. Many variations are possible. For example: high temperature alloys that are not compatible with commercial FFF AM extruders, but are compatible with purpose-built extruders; filaments with larger or smaller inset metal particles, or combinations thereof; inset metal particles with coatings to change the properties of the material in any state: multiple alloys of metal matrix or inset metal particles in the same filament; filaments with properties tailored for specific applications such as electronics, magnetics, high temperature, or corrosive environments, among others; inset metal particles of different geometries; and filament designed to be extruded from any filament-deposition based AM platform.

This description should not be construed as limiting the scope of the embodiments but as merely providing illustrations of some of several embodiments. For example, the metal matrix and inset metal particles can be made of different alloys, multiple alloys, or a metal other than solder paste such as metal powder, among other changes. Additionally, an example of one extrusion system is given, but many extrusion systems capable of extruding metal or plastic are sufficient to process the filament into its final form.

### Definitions

Unless otherwise defined herein, scientific and technical terms used in this application shall have the meanings that are commonly understood by those of ordinary skill in the art. Generally, nomenclature used herein is well-known and commonly used in the art.

Chemistry terms used herein, unless otherwise defined herein, are used according to conventional usage in the art, as exemplified by “The McGraw-Hill Dictionary of Chemical Terms”, Parker S., Ed., McGraw-Hill, San Francisco, C.A. (1985).

As used herein, the terms “weight percent” or “% w/w” are meant to refer to the quantity by weight of a compound and/or component in a composition as the quantity by weight of a constituent component of the composition as a percentage of the weight of the total composition. The weight percent can also be calculated by multiplying the mass fraction by 100. The “mass fraction” is the ratio of one substance of a mass mᵢ to the mass of the total composition m_{T} such that weight percent=(mᵢ/m_{T})*100.

As used herein, the term “alloy” refers to a partial or complete solid solution of one or more elements in a metallic matrix.

### EXAMPLES

The invention now being generally described, it will be more readily understood by reference to the following examples which are included merely for purposes of illustration of certain aspects and embodiments of the present invention and are not intended to limit the invention.

### Example 1: Preparation of a Metal Filament

An exemplary metal filament was constructed by thoroughly mixing two solder pastes of different alloys from SRA Soldering Products. A low temperature solder paste (alloy Sn42/Bi57/Ag1) was used for the matrix and a high temperature solder paste (alloy Sn96.5/Ag3.0/Cu0.5) was used for the inset metal particles, although other manufacturers, alloys, or products altogether different from solder paste may be used. This mixture was then heated to about 200° C., which is above the melting temperature of the low temperature alloy but below the melting temperature of the high temperature alloy, and the heated mixture was extruded into a long wire to form the exemplary metal FFF filament. The filament was extruded from a conventional 3D printer hotend (E3D V6) with modifications as follows: a larger nozzle to form correctly sized filament for use in commercial 3D printers, a syringe rather than a traditional extrusion system which was loaded with the solder paste mixture forced the mixture through the nozzle, a smaller heatsink so that the length of travel of the solder paste through the hotend was minimized.

### Example 2: Using a Metal Filament to Fabricate a Printed Product

The metal filament was loaded into the FFF 3D printer according to the instructions of the manufacturer of the specific machine. During the printing process, the hotend of the machine was heated to a temperature between the melting temperatures of the matrix and inset metal particles and the material was extruded through the nozzle. The metal filament did not form beads when extruded as the inset metal particles stabilized the filament while the molten metal matrix allowed the filament to flow out of the nozzle. After extrusion, the filament cooled and solidified, forming the printed shape.

### Example 3: Printing with a Standard Metal Alloy Versus a Metal Filament of the Disclosure

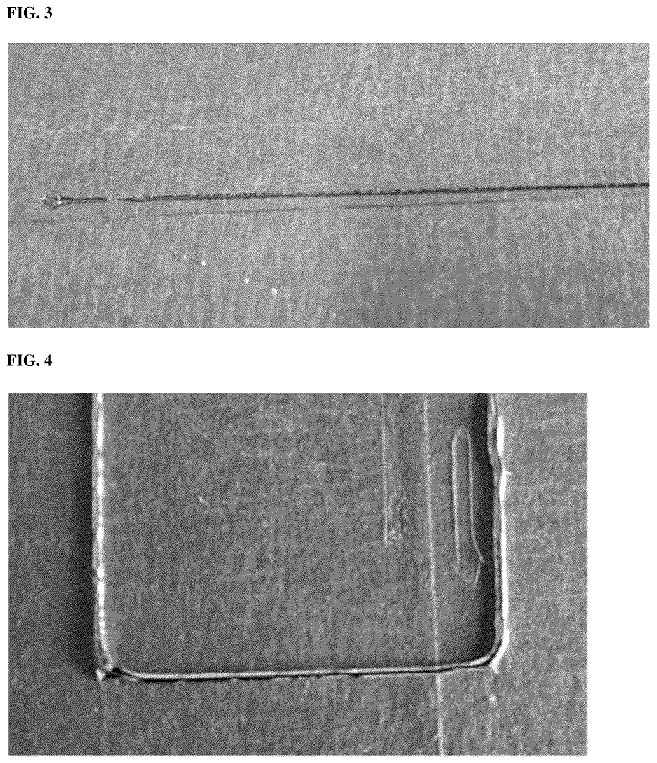

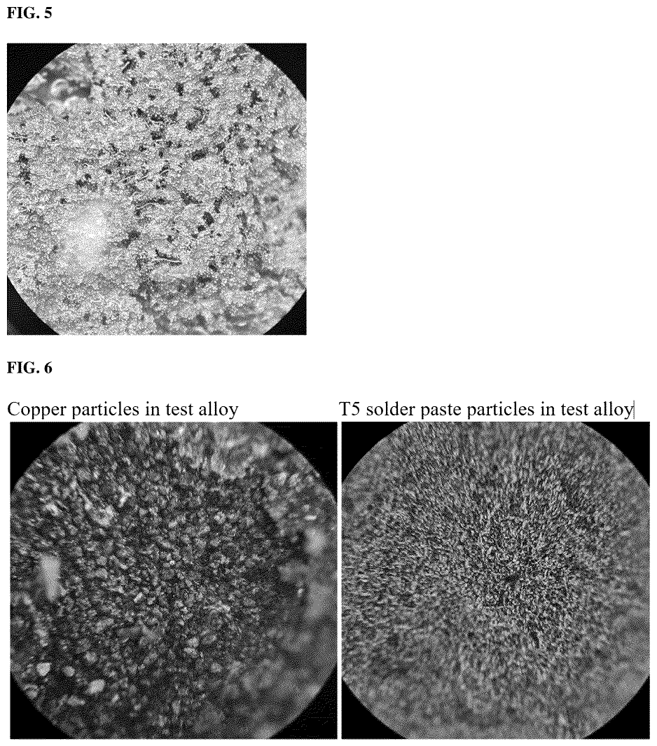

As shown in FIG. 2, printing with a standard metal alloy resulted in discrete globules of metal rather than a continuous line. This was due to the surface tension of the metal alloy and adhesion between the alloy and the 3D printing nozzle. FIG. 3 shows the results of printing using a metal filament having a matrix composition of Sn42/Bi57/Ag1 and a particle composition of Sn96.5/Ag3.0/Cu0.5. The resulting print is a continuous line of metal without any clumps or beads of material.

### Example 4: Resistivity of Metal Filament

Table 1 compares the resistivity of various conductive filaments with the calculated resistivity of a metal filament of the disclosure having a matrix composition of Sn42/Bi57/Ag1 and a particle composition of Sn96.5/Ag3.0/Cu0.5. Calculations are based on the measured resistivity of the matrix alloy, which is the primary component of the metal filament.

TABLE 1

| Material | Resistivity (Ω) | Measurement Source |
|---|---|---|
| Proto-Pasta Conductive Filament | 30 (parallel to | Proto-Pasta product CDP11705 web |
| | printed layers) | page |
| | 115 (perpendicular | |
| | to layers) | |
| Electrifi Conductive Filament | 0.006 | Multi3D product electrifi175 web |
| | | page |
| PEDOT:PSS Hydrogel | 0.036 | (Yuk et al., 2020) |
| PEDOT:PSS Dry-annealed | 0.0065 | (Yuk et al., 2020) |
| Copper Ink cured at 150° C. | 0.0002 | (Espalin et al., 2014) |
| Metal filament with matrix | 0.00002805 | Sn42/Bi57/Ag1: MG Chemicals |
| composition of Sn42/Bi57/Ag1 | | (supplier) Technical Data |
| and particle composition of | | Sheet Version 1.01 |
| Sn96.5/Ag3.0/Cu0.5. | | |
| Law of mixtures assuming no | | Sn96.5/Ag3.0/Cu0.5: MG |
| losses (low estimate) | | Chemicals (supplier) Technical |
| | | Data Sheet (Updated Apr. 28, 2010) |
| Metal filament with matrix | 0.00004929 | Sn42/Bi57/Ag1: MG Chemicals |
| composition of Sn42/Bi57/Ag1 | | (supplier) Technical Data |
| and particle composition of | | Sheet Version 1.01 |
| Sn96.5/Ag3.0/Cu0.5. | | Sn96.5/Ag3.0/Cu0.5: MG |
| Assumes particles are voids, no | | Chemicals (supplier) Technical |
| electron scattering (high estimate) | | Data Sheet (Updated Apr. 28, 2010) |

### Example 5: Filament Compositions

Table 2 outlines combinations of metal matrix alloys and particles that were tested in the development of metal filaments. Listed particles have the form factor used in the experiment after the alloy. T3 or T5 indicates an atomized metal particle used in solder pastes, T5 being a smaller average particle size than T3. Powder indicates a conventional metal powder. As shown in FIG. 6, the copper particles were larger and more angular than the T5 solder particles. As a result of their larger size and irregular shape, the copper particles experienced greater particle lock when flowing through the nozzle and often clumped together. By contrast, the Sn96.5/Ag3/Cu0.5 particles were nearly spherical and experienced minimal particle lock.

TABLE 2

| | | Formed |
|---|---|---|
| Matrix Alloys | Particles | Filaments? |
| Sn42/Bi57/Ag1 | Sn96.5/Ag3/Cu0.5 (T3) | Yes |
| Sn45/Bi55 | Copper (powder) | No |
| Sn45/Bi55 | Sn96.5/Ag3/Cu0.5 (T5) | Yes |
| Sn37.5/Bi62.5 | Copper (powder) | No |
| Sn37.5/Bi62.5 | Sn96.5/Ag3/Cu0.5 (T5) | Yes |

### INCORPORATION BY REFERENCE

All publications and patents mentioned herein are hereby incorporated by reference in their entirety as if each individual publication or patent was specifically and individually indicated to be incorporated by reference. In case of conflict, the present application, including any definitions herein, will control.

### EQUIVALENTS

While specific embodiments of the subject invention have been discussed, the above specification is illustrative and not restrictive. Many variations of the invention will become apparent to those skilled in the art upon review of this specification and the claims below. The full scope of the invention should be determined by reference to the claims, along with their full scope of equivalents, and the specification, along with such variations.

1. A metal filament comprising a plurality of metal particles embedded within a metal matrix, wherein:
the metal matrix comprises:
about 30% to about 99.9% tin (w/w);
about 0% to about 70% bismuth (w/w);
about 0% to about 5% silver (w/w); and
about 0% to about 5% copper; and
the metal particles comprise:
about 0% to about 99% tin (w/w);
about 0% to about 5% silver (w/w); and
about 0.1% to about 100% copper (w/w).

2. (canceled)

3. The metal filament of claim 1, wherein the metal matrix comprises:
about 30% to about 50% tin (w/w);
about 50% to about 70% bismuth (w/w); and
about 0% to about 5% silver (w/w).

4. The metal filament of claim 1, wherein the metal matrix comprises about 30%, about 30.5%, about 31%, about 31.5%, about 32%, about 32.5%, about 33%, about 33.5%, about 34%, about 34.5%, about 35%, about 35.5%, about 36%, about 36.5%, about 37%, about 37.5%, about 38%, about 38.5%, about 39%, about 39.5%, about 40%, about 40.5%, about 41%, about 41.5%, about 42%, about 42.5%, about 43%, about 43.5%, about 44%, about 44.5%, about 45%, about 45.5%, about 46%, about 46.5%, about 47%, about 47.5%, about 48%, about 48.5%, about 49%, about 49.5%, or about 50% tin (w/w).

5-7. (canceled)

8. The metal filament of claim 1, wherein the metal matrix comprises about 50%, about 50.5%, about 51%, about 51.5%, about 52%, about 52.5%, about 53%, about 53.5%, about 54%, about 54.5%, about 55%, about 55.5%, about 56%, about 56.5%, about 57%, about 57.5%, about 58%, about 58.5%, about 59%, about 59.5%, about 60%, about 60.5%, about 61%, about 61.5%, about 62%, about 62.5%, about 63%, about 63.5%, about 64%, about 64.5%, about 65%, about 65.5%, about 66%, about 66.5%, about 67%, about 67.5%, about 68%, about 68.5%, about 69%, about 69.5%, or about 70% bismuth (w/w).

9-11. (canceled)

12. The metal filament of claim 1, wherein the metal matrix comprises about 0.1%, about 0.2%, about 0.3%, about 0.4%, about 0.5%, about 0.6%, about 0.7%, about 0.8%, about 0.9%, about 1.0%, about 1.1%, about 1.2%, about 1.3%, about 1.4%, about 1.5%, about 1.6%, about 1.7%, about 1.8%, about 1.9%, about 2.0%, about 2.1%, about 2.2%, about 2.3%, about 2.4%, about 2.5%, about 2.6%, about 2.7%, about 2.8%, about 2.9%, about 3.0%, about 3.1%, about 3.2%, about 3.3%, about 3.4%, about 3.5%, about 3.6%, about 3.7%, about 3.8%, about 3.9%, about 4.0%, about 4.1%, about 4.2%, about 4.3%, about 4.4%, about 4.5%, about 4.6%, about 4.7%, about 4.8%, about 4.9%, or about 5.0% of silver (w/w).

13. (canceled)

14. The metal filament of claim 1, wherein the metal matrix comprises 0% silver (w/w).

15. The metal filament of claim 1, wherein the metal matrix comprises 0% copper (w/w).

16. The metal filament of claim 1, wherein the metal matrix comprises about 42% tin, about 57% bismuth, and about 1% silver (w/w).

17. The metal filament of claim 1, wherein the metal matrix comprises about 45% tin and about 55% bismuth (w/w).

18. The metal filament of claim 1, wherein the metal matrix comprises about 37.5% tin and about 62.5% bismuth (w/w).

19-20. (canceled)

21. The metal filament of claim 1, wherein the metal matrix comprises about 99.3% tin and about 0.7% copper (w/w).

22. The metal filament of claim 1, wherein the metal particles comprise:
about 90% to about 99% tin (w/w);
about 1% to about 5% silver (w/w); and
about 0.1% to about 3% copper (w/w).

23. The metal filament of claim 1, wherein the metal particles comprise about 90%, about 90.5%, about 91%, about 91.5%, about 92%, about 92.5%, about 93%, about 93.5%, about 94%, about 94.5%, about 95%, about 95.5%, about 96%, about 96.5%, about 97%, about 97.5%, about 98%, about 98.5%, or about 99% tin (w/w).

24. (canceled)

25. The metal filament of claim 1, wherein the metal particles comprise about 1%, about 1.5%, about 2%, about 2.5%, about 3%, about 3.5%, about 4%, about 4.5%, or about 5% silver (w/w).

26. (canceled)

27. The metal filament of claim 1, wherein the metal particles comprise about 0.1%, about 0.2%, about 0.3%, about 0.4%, about 0.5%, about 0.6%, about 0.7%, about 0.8%, about 0.9%, about 1.0%, about 1.1%, about 1.2%, about 1.3%, about 1.4%, about 1.5%, about 1.6%, about 1.7%, about 1.8%, about 1.9%, about 2.0%, about 2.1%, about 2.2%, about 2.3%, about 2.4%, about 2.5%, about 2.6%, about 2.7%, about 2.8%, about 2.9%, or about 3.0% copper (w/w).

28. (canceled)

29. The metal filament of claim 1, wherein the metal particles comprise about 96.5% tin, about 3% silver, and about 0.5% copper (w/w).

30. The metal filament of claim 1, wherein the metal particles comprise about 100% copper (w/w).

31-41. (canceled)

42. A method of making the metal filament of claim 1, comprising:
providing a first metal paste and a second metal paste, wherein:
the first metal paste comprises:
about 30% to about 99.9% tin (w/w);
about 0% to about 70% bismuth (w/w);
about 0% to about 5% silver (w/w); and
about 0% to about 5% copper (w/w); and
wherein the second metal paste comprises:
about 0% to about 99% tin (w/w);
about 0% to about 5% silver (w/w); and
about 0.1% to about 100% copper (w/w);
mixing the first paste and the second metal paste to form a mixture;
heating the mixture to a temperature above a melting temperature of the first metal paste but below a melting temperature of the second metal paste, thereby forming a heated mixture; and
extruding the heated mixture through a nozzle to form the metal filament of claim 1.

43-72. (canceled)

73. A method of using the metal filament of claim 1 for fused filament fabrication with a 3D printer or a method of using the metal filament of claim 1 to print a continuous line of material.

74-78. (canceled)
